(19) United States
(12) Patent Application Publication
(10) Pub. No.: US 2012/0012619 A1
(43) Pub. Date: Jan. 19, 2012

(54) BRIDGE BREAKER

(76) Inventor: Shuichi OKABE, Kawaguchi-shi (JP)

(21) Appl. No.: 12/849,116

(22) Filed: Aug. 3, 2010

(30) Foreign Application Priority Data
Jul. 16, 2010 (JP) 2010-161419

(51) Int. Cl. G01F 11/20

(52) U.S. Cl. 222/410

(57) ABSTRACT

A bridge breaker has balls between casing and inner ring for supporting inner ring as rotatable without independent ball bearings for easiness and cost down of machining, and seal rings having square shape section are laid on same horizontal level surfaces of casing and inner ring and depressed by air pressure for preventing powder entering into the device and frequent exchange of packing, and blade is fixed to inner ring by connection by shaft and hole for preventing troubles caused by looseness or leasing of connecting bolts.

### BACKGROUND OF THE INVENTION

1. Field of the Invention

The present invention relates to bridge breaker for the powder or particle (hereinafter called as powder) discharging system from receiving hopper to outside directly or downstream equipment. This device is usually equipped at the bottom of hopper and used to break plugging of powder (hereinafter called as bridge) happened at cone part of hopper by rotating a blade with motor.

Vibrator or knocker equipped at cone part of hopper is known for breaking bridge. But vibration or shock sometimes can't solve bridge, because powder is packed by vibration or shock and make situation worse. And wall of hopper is damaged by repeated stress for long period of operation by force of vibrator or knocker. Furthermore, in case of knocker, big noise happened.

Air injection into hopper is another way for breaking bridge. But in case of small amount of air, bridge can't be solved, and in case of large amount of air, releasing air from hopper is difficult because air contains a lot of powder, and much cost is required for air consumption.

The present invention relates to bridge breaker can solve bridge certainly without problems of damage of hopper, noise and cost for injection air.

2. Description of the Related Art

With respect to bridge breaker, the device as shown in FIG. 1 is used conventionally.

In this figure, upper part of the device is connected with flange C of hopper A having cone B by bolts, and lower part of the device is connected with flange D of downstream equipment. The clearance between flange C and the device is sealed by packing E, and clearance between flange D and the device is sealed by packing F.
Casing 1 having upper flange 1a, lower flange 1b and gear box 1c is divided into upper part and lower part to enable assembling of inside parts though demarcation line of them and connecting bolts are not shown in FIG. 1.
   Inner ring 2 having flange 2a is enclosed by casing 1 and connected with casing 1 by ball bearing 4 with bolts 5 as rotatable.
Blade 3 has upper part 3a which inclines as parallel to surface of cone B and lower part 3b which is vertical. Lower part 3b is connected with inner ring 2 by bolts 3c.
Packing 6 and 7 such as oil seal or grand packing are provided between casing 1 and inner ring 2 at both parts of top and bottom to prevent entering of powder into the device.
Chain sprocket 8 is connected with flange 2a of inner ring 2 and ball bearing 4 by bolts 11.
Geared motor 12 is connected with gear box 1c by bolts and output shaft 12a is inserted into gear box 1c.
Chain sprocket 10 is fitted output shaft 12a of geared motor 12 by key and bolts.
Link chain 9 ties chain sprocket 8 and chain sprocket 10 to transfer rotating torque of geared motor 12 to inner ring 2.
   Bridge of powder is broken by rotating of blade 3, even slow rotating speed such as 0.5-3 rpm.

However, there are problems as for conventional bridge breaker.
1) Ball bearing 4 receives heavy axial force by gravity of powder, and deformation of ball bearing 4 causes troubles such as stop of operation or early wearing of ball bearing. So, housings of ball bearing 4 should have enough sturdiness, or should be fitted to casing 1 with severe tolerance to utilize sturdiness of casing 1 and inner ring 2.
   However because of large diameter such as over 200 mm, fabrication of ball bearing 4, and machining of fitted parts between ball bearing 4 and casing 1, and between ball bearing 4 and inner ring 2 are difficult. So much cost and time are required for machining.
2) Packing 6, 7 receive severe abrasion and quick wearing because of existence of powder. Touching parts of packing 6, 7 are worn in a few month of operation, and powder enters into inside of device, and finally operation can't be continued.
3) Bolts 3c to fix blade 3 to inner ring 2 are loosened easily, and additional fastening of bolts 3c is impossible during operation. Once bolts 3c are released, bolts 3c cause troubles of contamination of powder and damage of downstream equipment.
   Furthermore sometimes screw of bolts 3c is stuck in screwed holes, and a lot of repair work is necessary.

### SUMMARY OF THE INVENTION

The present invention has objects to provide a bridge breaker that can solve the essential problems of the conventional bridge breaker described above.

The present invention is a bridge breaker consists of casing, rotatable inner ring, blade, balls between casing and inner ring, plug, seal rings, between casing and inner ring, middle gears, drive gear and geared motor.

In order to attain the above object, according to a first aspect of the present invention, there is provided inner ring supported as rotatable by balls and grooves on outside surface of inner ring and on inside surface of casing, and hole for charging balls from outside of casing to these grooves at assembly, and plug to stop this hole.

According to a second aspect of the present invention, there is provided seal rings having sectional shape of square at the clearances between inner ring and casing, and touching at lower side surface of them to horizontal surfaces of inner ring and casing, and depressed by pressure of purge air introduced into device.

According to a third aspect of the present invention, there is provided blade having machined shaft inserted into hole of inner ring.

### BRIEF DESCRIPTION OF THE DRAWINGS

FIGS. 2, 3, 4 and 5 show the main parts and layout of the present invention.

FIG. 2 is vertical section view and FIG. 3 is horizontal section view.

FIG. 3 shows detail layout of seal rings.

FIG. 5 shows detail layout of connection between blade and inner ring.

Wherein

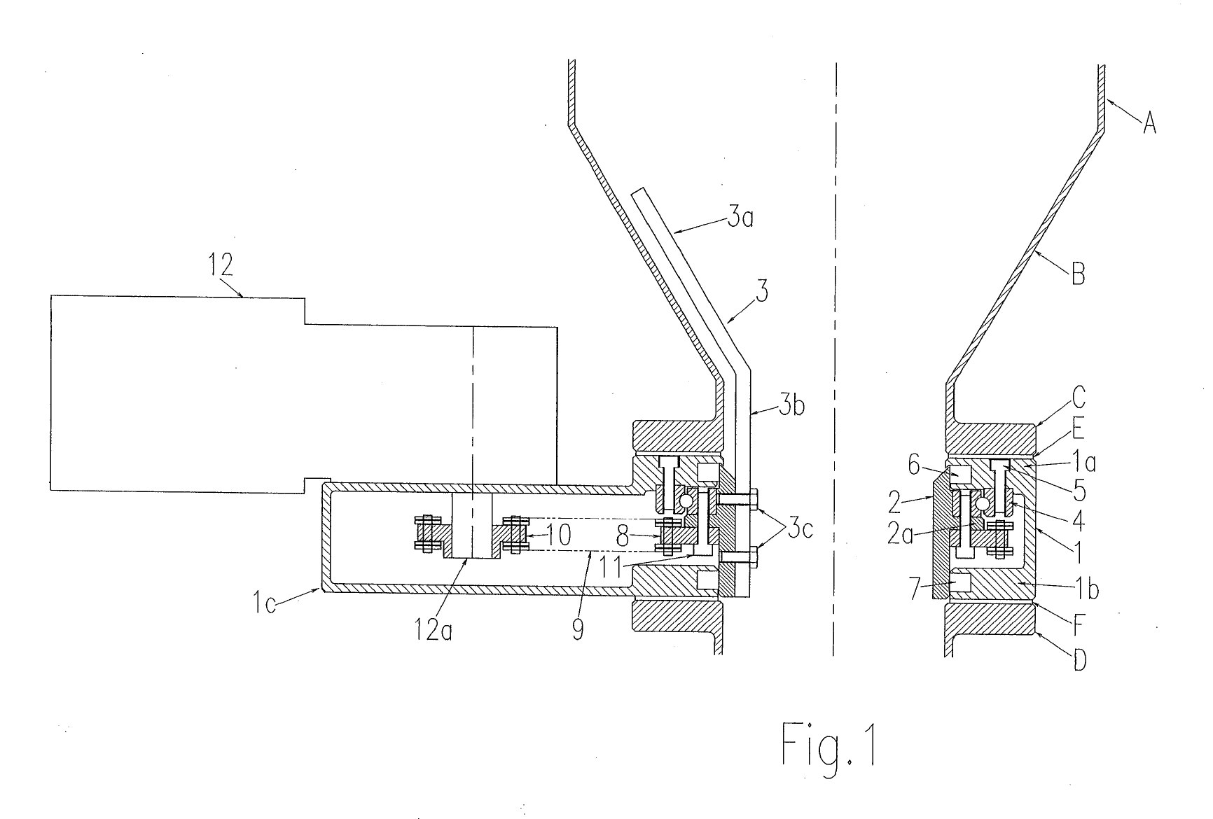

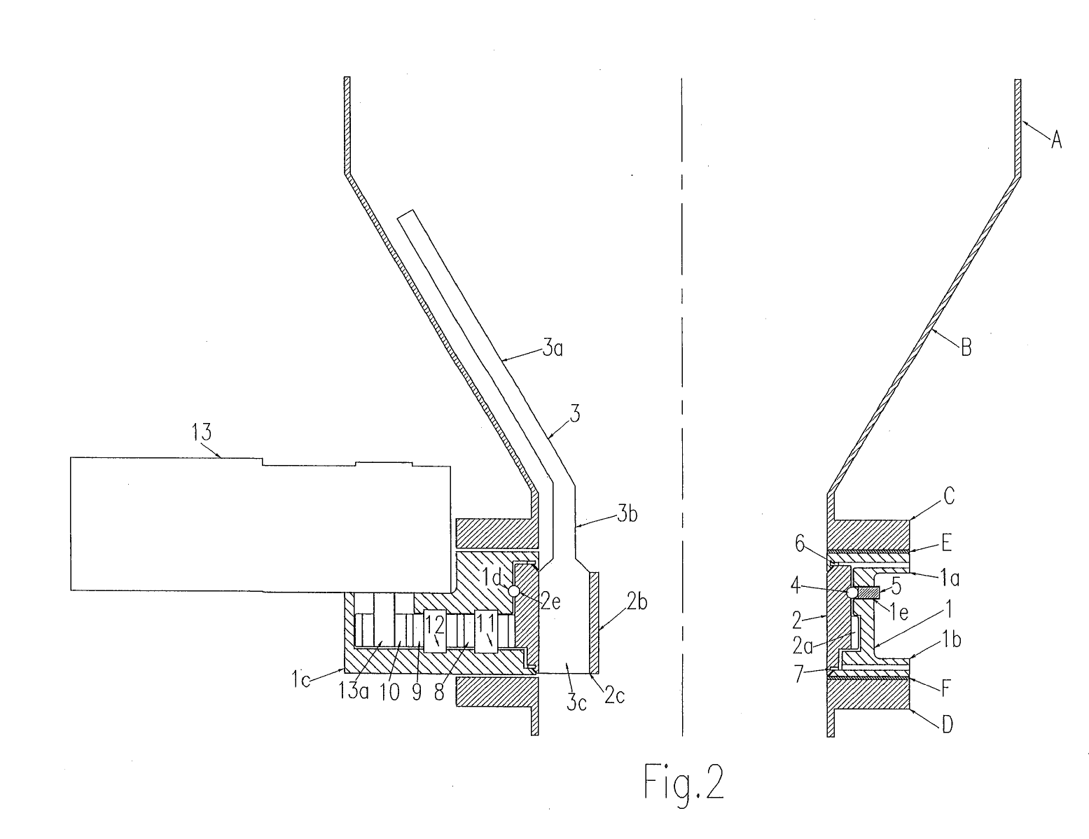

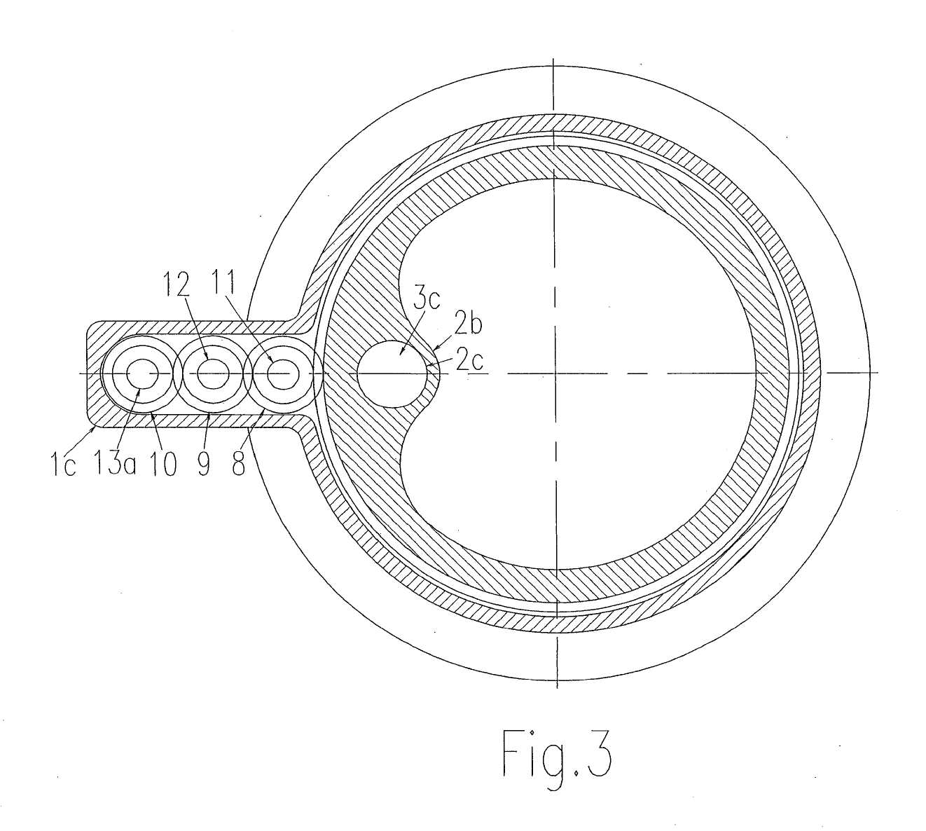

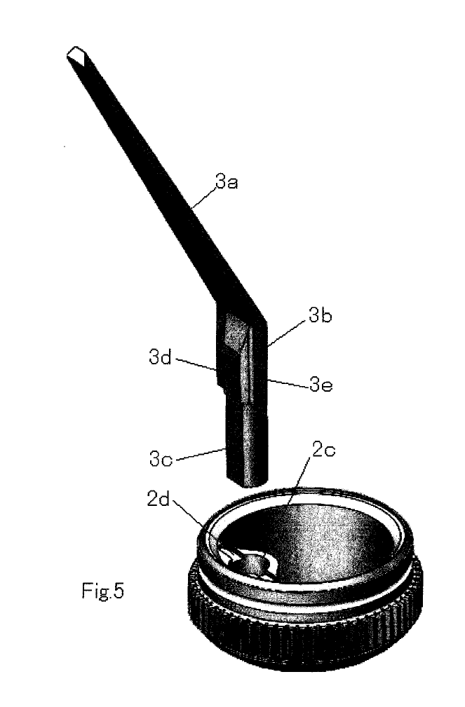

hopper A to which this device is connected, having cone B and flange C, and flange D of downstream device to which this device is connected, and packing E, F for connecting flange surfaces of this device, and
casing 1 consists of upper casing and lower casing connected with each other by bolts though the demarcation line and bolts are not shown in FIG. 2,
   having upper flange 1a and lower flange 1b and gear box 1c, and
   having groove 1d on inner surface and a hole 1e between outer surface and groove 1d, and
inner ring 2 enclosed in casing 1 and having gear 2a, overhang part 2b, hole 2c, and groove 2e on outer surface, and
blade 3 consists of upper blade 3a, vertical part 3b and shaft 3c, and vertical ribs 3d and 3e as shown in FIG. 5, and
balls 4 charged in grooves 1d and 2e, and
screwed plug 5 fitted to hole 1e, and
seal rings 6 and 7 having square shape section, made of PTFE or other materials, and
middle gears 8 and 9, and
drive gear 10, and
shafts 11 and 12 for supporting middle gears 8 and 9, and
geared motor 13 having output shaft 13a.

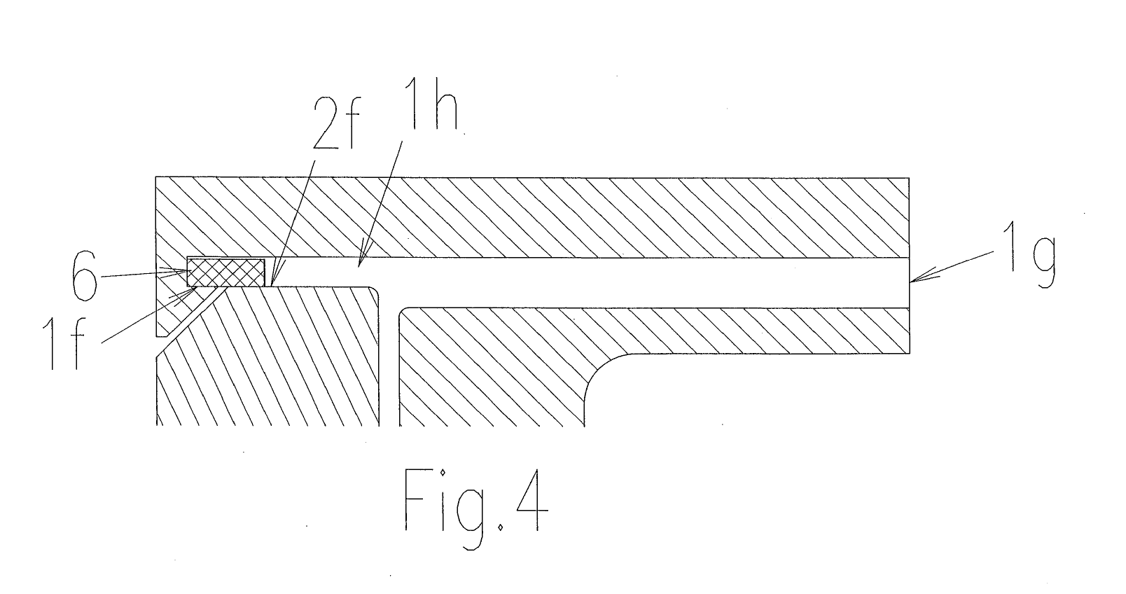

As shown in FIG. 4, contacting surface 1f of casing 1 and contacting surface 2f of inner ring 2 to seal ring 6 are same horizontal level.

And purge air hole 1g is provided between circumferential space 1h and outer surface of upper flange 1a. As for seal ring 7, the construction is same as seal ring 6.

As shown in FIG. 5, for fixing blade 3 to inner ring 2, shaft 3c of blade 3 is inserted into hole 2c of inner ring 2, and vertical ribs 3d and 3e of blade 3 are inserted into groove 2d of inner ring 2.

### DETAILED DESCRIPTION OF THE PREFERRED EMBODIMENT

In order to attain the above object, according to a first aspect of the present invention, there is provided inner ring supported as rotatable by balls and grooves on outside surface of inner ring and on inside surface of casing, and hole for charging balls from outside of casing to these grooves at assembly, and plug to stop this hole.

Casing 1 and inner ring 2 have enough sturdiness compared with independent ball bearing to support load for balls 4 during operation and also load by clamping force during machining. On the other hand, small clearance such as 0.1 mm between balls 4 and grooves 1d, 2e is necessary to allow smooth moving of balls even in case of independent ball bearing. This means machining of grooves 1d and 2e is easier than fitting independent ball bearing to casing 1 and inner ring 2.

Therefore, cost and difficulty of machining are much saved.

In order to attain the above object, according to a second aspect of the present invention, there is provided seal rings having sectional shape of square at the clearances between inner ring and casing, and touching at lower side surface of them to horizontal surfaces of inner ring and casing, and depressed by pressure of air introduced into device.

Air or other gas such as nitrogen having higher pressure than inner pressure of this device is introduced from outside of casing 1 through hole 1g to circumferential space 1h, and depress seat ring 6 to horizontal surfaces 1f and 2f. There might be small clearance between seat ring 6 and horizontal surfaces 1f and 2f caused by allowable tolerance during fabrication such as 0.1 mm.

Air passes through this clearance with high speed more than 10 m/second and powder can't enter into this clearance from inside of this device against air flow. By using material having low abrasion factor such as PTFE for seat rings, and by reason of low depressing force to seat ring 6 by air, wearing of seat rings is much reduced and almost negligible. The situation of seat ring 7 is same as seal ring 6.

In order to attain the above object, according to a third aspect of the present invention, there is provided blade having machined shaft inserted into hole of inner ring.

Blade 3 can't be raised up because of its gravity, and blade 3 receives downwards force by powder in hopper A because of inclination of blade 3. Vertical ribs 3d,3e inserted into groove 2d prevents turning of blade 3. Therefore blots are not necessary to fix blade 3 and there is no risk that bolts are loosened or released during operation or screws of bolts are stuck in screwed hole during disassembling of blade 3 from inner ring 2.

Connection by shaft and hole has much sturdiness and less looseness than connection by bolts. So there is no risk of troubles for fixing blade.

1. A bridge breaker having:
inner ring supported as rotatable by balls and grooves on outside surface of inner ring and on inside surface of casing, and hole for charging balls from outside of casing to these grooves at assembly, and plug to stop this hole.

2. Seal rings having sectional shape of square at the clearances between inner ring and casing, and touching at lower side surface of them to horizontal surfaces of inner ring and casing, and depressed by pressure of air or other gas introduced into device, according to claim 1.

3. Blade having machined shaft inserted into hole of inner ring, according to claim 1.
